(19) United States
(12) Patent Application Publication
(10) Pub. No.: US 2016/0189216 A1
(43) Pub. Date: Jun. 30, 2016

(54) INFORMATION PUSHING METHOD AND COMMUNICATION SYSTEM

(71) Applicant: KIMREE HI-TECH INC., Tortola (VG)

(72) Inventor: Qiuming Liu, Huizhou (CN)

(21) Appl. No.: 15/062,618

(22) Filed: Mar. 7, 2016

Related U.S. Application Data
(63) Continuation of application No. PCT/CN2014/078605, filed on May 28, 2014.

(51) Int. Cl. G06Q 30/02; G06Q 10/08; G01P 13/00; A24F 47/00

(52) U.S. Cl. CPC G06Q 30/0255; A24F 47/008; G06Q 10/087; G01P 13/0006

(57) ABSTRACT

An information pushing method and a communication system are provided. A user terminal receives information on an amount of remaining tobacco tar from an electronic cigarette bound with the user terminal. The user terminal determines whether the amount of the remaining tobacco tar is smaller than a preset value according to the information on the amount of the remaining tobacco tar. If the amount of the remaining tobacco tar is smaller than the preset value, the user terminal transmits request information to a service platform. The user terminal receives information about electronic cigarette accessories from the service platform. The user terminal presents the information about electronic cigarette accessories to a user.

### CROSS-REFERENCE TO RELATED APPLICATION

The application is a continuation application of International Application PCT/CN2014/078605, titled “INFORMATION PUSHING METHOD AND COMMUNICATION SYSTEM”, and filed on May 28, 2014, which is incorporated herein by reference in its entirety.

### FIELD

Embodiments of the disclosure relate to the communication field, in particular to an information pushing method and a communication system.

### BACKGROUND

An electronic cigarette is new electronic product, having similar appearance and similar taste to a normal cigarette. But compared with the normal cigarette, the electronic cigarette is healthier and more environmental.

With more and more users using the electronic cigarette, more requirements are placed on functions which the electronic cigarette may provide. The conventional electronic cigarette may detect current remaining puff number, and in a case that the remaining puff number is insufficient, the electronic cigarette may notify the user to increase tobacco tar through flashing light or notification tone, etc.

In above conventional technology, the electronic cigarette may detect remaining puff number currently, but in a case that the remaining puff number is insufficient, the electronic cigarette can only notify the user, and can not provide more information to the user to facilitate selection of the user.

### SUMMARY

An information pushing method and a communication system are provided according to embodiments of the disclosure, which may accurately push information to a user to facilitate user selection.

The information pushing method according to the embodiment of the disclosure includes:

receiving, by a user terminal, information on an amount of remaining tobacco tar from an electronic cigarette bound with the user terminal,

determining, by the user terminal, whether the amount of the remaining tobacco tar is smaller than a preset value according to the information on the amount of the remaining tobacco tar,

in response to the amount of the remaining tobacco tar being smaller than the preset value, transmitting, by the user terminal, request information to a service platform,

receiving, by the user terminal, information about electronic cigarette accessories from the service platform, and

presenting, by the user terminal, the information about electronic cigarette accessories to a user.

Optionally, before receiving information on an amount of remaining tobacco tar from an electronic cigarette bound with the user terminal, the method comprises:

determining, by the electronic cigarette, whether the user is puffing on the electronic cigarette,

in response to the user being puffing on the electronic cigarette, determining, by the electronic cigarette, whether a client on the user terminal is in a standby state,

in response to the client on the user terminal being in the standby state, transmitting, by the electronic cigarette, the information on the amount of the remaining tobacco tar to the user terminal through a wireless network.

Optionally, determining whether a client on the user terminal is in a standby state comprises:

transmitting, by the electronic cigarette, a client detection message to the user terminal,

determining, by the electronic cigarette, whether a client response message is received from the user terminal,

in response to the client response message being received, determining, by the electronic cigarette, that the client on the user terminal is in the standby state.

Optionally, transmitting the information on the amount of the remaining tobacco tar to the user terminal through a wireless network comprises:

transmitting, by the electronic cigarette, data of valuePair type to the user terminal through the wireless network, wherein the data of the valuePair type represents the information on the amount of the remaining tobacco tar.

Optionally, transmitting the information on the amount of the remaining tobacco tar to the user terminal through a wireless network comprises:

transmitting, by the electronic cigarette, data of JSON type to the user terminal through the wireless network, wherein the data of the JSON type comprises the information on the amount of the remaining tobacco tar.

Optionally, before determining whether the amount of the remaining tobacco tar is smaller than a preset value, the method comprises:

converting, by the user terminal, the data of the JSON type into a JSONObject object; and

extracting, by the user terminal, the information on the amount of the remaining tobacco tar from the JSONObject object according to a field identifier.

Optionally, before transmitting request information to a service platform, the method comprises:

presenting, by the user terminal, selection information to the user;

in response to the user selecting to receive information pushed by the service platform, triggering, by the user terminal, the step of transmitting request information to a service platform; and

in response to the user selecting not to receive information pushed by the service platform, stopping, by the user terminal, executing operation.

Optionally, before transmitting the information on the amount of the remaining tobacco tar to the user terminal through a wireless network, the method comprises:

counting, by a counter of the electronic cigarette, outputs of a sensor of the electronic cigarette to determine puff number of the remaining tobacco tar, wherein the puff number of the remaining tobacco tar is taken as the information on the amount of the remaining tobacco tar.

Optionally, the sensor includes an airflow sensing switch or a button switch, and the button switch includes a tact switch or a sensing switch.

Optionally, before transmitting the information on the amount of the remaining tobacco tar to the user terminal through a wireless network, the method comprises:

detecting, by a liquid level detector of the electronic cigarette, height of a surface of the tobacco tar of the electronic cigarette in a preset state to determine the information on the amount of the remaining tobacco tar.

Optionally, the electronic cigarette is perpendicular or parallel to the horizontal plane.

Optionally, the wireless network is a bluetooth network, a wireless fidelity (WIFI) network, an infrared network or a near field communication (NFC) network.

Optionally, the user terminal is a cellphone, a personal computer, a laptop or a tablet computer.

The communication system provided according to the embodiment of the disclosure includes:

an electronic cigarette, a user terminal and a service platform, where the electronic cigarette is bound with the user terminal;

the user terminal is configured to: receive information on an amount of remaining tobacco tar from the electronic cigarette,
determine whether the amount of the remaining tobacco tar is smaller than a preset value according to the information on the amount of the remaining tobacco tar,
in response to the amount of the remaining tobacco tar being smaller than the preset value, transmit request information to the service platform,
receive information about electronic cigarette accessories from the service platform, and
present the information about electronic cigarette accessories to a user.

Optionally, the electronic cigarette is configured to: determine whether the user is puffing on the electronic cigarette,

in response to the user being puffing on the electronic cigarette, determine whether a client on the user terminal is in a standby state, and

in response to the client on the user terminal being in the standby state, transmit the information on the amount of the remaining tobacco tar to the user terminal through a wireless network.

Optionally, the user terminal is further configured to: present selection information to the user;

in response to the user selecting to receive information pushed by the service platform, triggers the function for transmitting the request information to the service platform; and

in response to the user selecting not to receive information pushed by the service platform, stops executing operation.

Optionally, the electronic cigarette is configured to use a counter to count outputs of a sensor of the electronic cigarette to determine puff number of the remaining tobacco tar, wherein the puff number of the remaining tobacco tar is taken as the information on the amount of the remaining tobacco tar.

Optionally, the sensor is an airflow sensing switch or a button switch which is a tact switch or a sensing switch.

Optionally, the electronic cigarette is configured to use a liquid level detector to detect height of a surface of the tobacco tar of the electronic cigarette in a preset state to determine the information on the amount of the remaining tobacco tar.

Optionally, the electronic cigarette is perpendicular or parallel to the horizontal plane.

Optionally, the wireless network is a bluetooth network, a WIFI network, an infrared network or a NFC network.

Optionally, the user terminal is a cellphone, a personal computer, a laptop or a tablet computer.

It is can be seen from above technical solutions that the embodiments of the disclosure have following advantages.

According to the embodiments of the disclosure, having received information on amount of remaining tobacco tar from an electronic cigarette, the user terminal determines whether amount of remaining tobacco tar is smaller than a preset value. If the amount of remaining tobacco tar is smaller than the preset value, the user terminal transmits the request information to a service platform and presents to the user information about electronic cigarette accessories which is fed back by the service platform. Thus in a case that the amount of remaining tobacco tar is small, the information about electronic cigarette accessories which the user concerns may be pushed to the user, so as to implement accurate information push.

### BRIEF DESCRIPTION OF THE DRAWINGS

To describe the technical solutions for the embodiment of the present disclosure or technical solution in conventional technology more clearly, the following briefly describes the drawings involved in the embodiments of the present disclosure or in the conventional technology. Apparently, the drawings described below are some embodiments, and persons of ordinary skill in the art can derive other drawings according to the drawings without any creative effort.

FIG. 1 is a schematic diagram of an information pushing method provided according to an embodiment of the disclosure;

FIG. 2 is a schematic diagram of an information pushing method provided according to another embodiment of the disclosure;

FIG. 3 is a schematic diagram of an information pushing method provided according to still another embodiment of the disclosure;

FIG. 4 is a schematic diagram of a communication frame provided according to the disclosure; and

FIG. 5 is a schematic diagram of a communication system provided according to an embodiment of the disclosure.

### DETAILED DESCRIPTION

Technical solutions of the embodiments of the present disclosure will be illustrated completely and clearly with the following drawings of the embodiments of the disclosure. Apparently, the described embodiments are merely a few rather than all of the embodiments of the present disclosure. All other embodiments obtained by persons of ordinary skill in the art based on the embodiments of the present disclosure without creative efforts shall fall within the protection scope of the present disclosure.

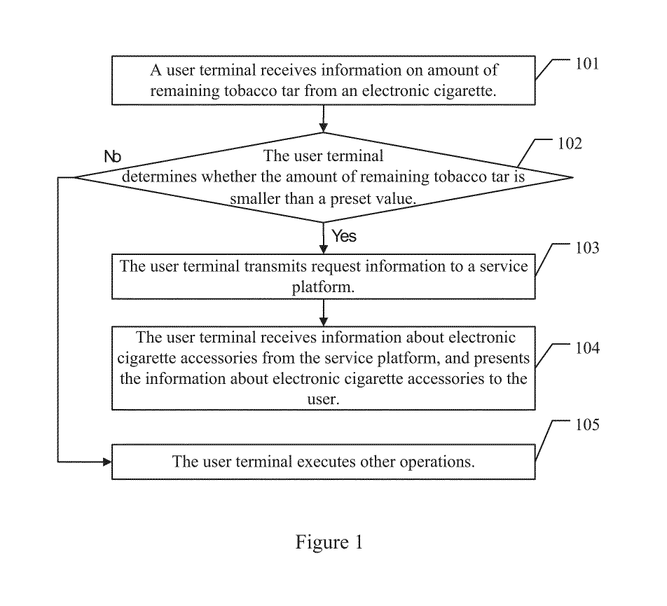

Referring to FIG. 1, an information pushing method according to an embodiment of the disclosure includes following steps.

At 101, a user terminal receives information on amount of remaining tobacco tar from an electronic cigarette.

According to the embodiment, the user terminal may be bound with the electronic cigarette in advance. The user terminal, which has been bound with the electronic cigarette, may receive the information on amount of remaining tobacco tar from the electronic cigarette.

At 102, the user terminal determines whether the amount of remaining tobacco tar is smaller than a preset value, if the amount of remaining tobacco tar is smaller than the preset value, step 103 is executed; otherwise, step 105 is executed.

Having received the information on the amount of remaining tobacco tar from the electronic cigarette, the user terminal determines whether the amount of remaining tobacco tar is smaller than the preset value according to the information on the amount of remaining tobacco tar, if the amount of remaining tobacco tar is smaller than the preset value, step 103 is executed; otherwise, step 105 is executed.

At 103, the user terminal transmits request information to a service platform.

According to the embodiment, if the user terminal determines that the amount of remaining tobacco tar of the electronic cigarette is smaller than the preset value, it is illustrated that tobacco tar is insufficient currently. Then the user terminal may transmit the request information to the service platform to request the service platform to feed back corresponding information.

At 104, the user terminal receives information about electronic cigarette accessories from the service platform, and presents the information about electronic cigarette accessories to the user.

According to the embodiment, the user terminal transmits the request information to the service platform, and then the service platform feeds back information about electronic cigarette accessories to the user terminal. The user terminal may receive the information about electronic cigarette accessories and present the information about electronic cigarette accessories to the user.

At 105, the user terminal executes other operations.

According to the embodiment, if the user terminal determines that the amount of remaining tobacco tar of the electronic cigarette is above the preset value, it is illustrated that tobacco tar is sufficient currently. The user terminal may execute other operations, such as recording the amount of remaining tobacco tar or presenting the amount of remaining tobacco tar to the user, etc, which are not limited herein.

According to the embodiment of the disclosure, having received the information on amount of remaining tobacco tar from the electronic cigarette, the user terminal determines whether the amount of remaining tobacco tar is smaller than the preset value. If the amount of remaining tobacco tar is smaller than the preset value, the user terminal transmits the request information to the service platform and presents to the user the information about electronic cigarette accessories which is fed back by the service platform. Thus, in a case that the amount of remaining tobacco tar is small, the information about electronic cigarette accessories which the user concerns may be pushed to the user, so as to implement accurate information push.

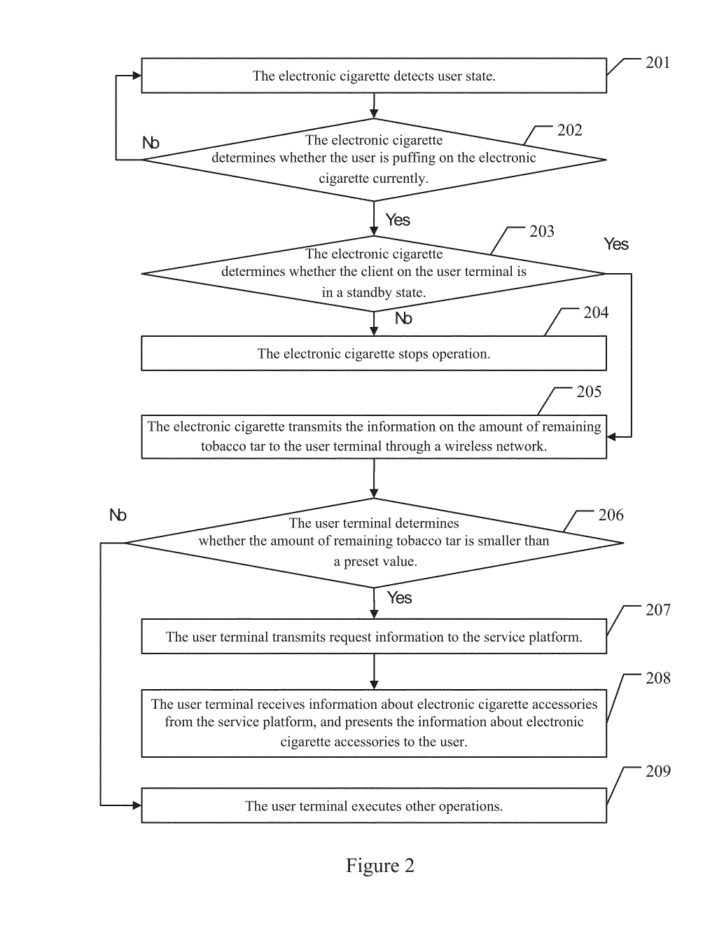

Referring to FIG. 2, the information pushing method according to another embodiment of the disclosure includes following steps.

At 201, the electronic cigarette detects user state.

According to the embodiment, the electronic cigarette may detect the user state to acquire current user state such as the user being smoking, the user being about to smoke, the user closing the electronic cigarette, etc, which is not limited herein.

At 202 the electronic cigarette determines whether the user is puffing on the electronic cigarette currently. If the user is puffing on the electronic cigarette currently, step 203 is executed, and if the user is not puffing on the electronic cigarette currently, step 201 is executed.

Having detected the user state, the electronic cigarette may acquire the current user state, to determine whether the user is puffing on the electronic cigarette currently. If the user is puffing on the electronic cigarette currently, step 203 may be executed, if the user is not puffing on the electronic cigarette currently, step 201 may be executed repeatedly.

It should be illustrated that the electronic cigarette may determine whether the user is puffing on the electronic cigarette currently in various ways. For example, the electronic cigarette may determine whether the user is puffing on the electronic cigarette according to operation state of an atomizer assembly of the electronic cigarette. In a case that the atomizer assembly is operating, it is may be determined that the user is puffing on the electronic cigarette.

Alternatively, the electronic cigarette may determine whether the user is puffing on the electronic cigarette according to operation state of a sensor of the electronic cigarette. In a case that the sensor is operating, it is may be determined that the user is puffing on the electronic cigarette currently.

Alternatively, the electronic cigarette may determine whether the user is puffing on the electronic cigarette according to consumption rate of battery power of the electronic cigarette. In a case that the consumption rate of battery power is greater than a threshold, it is may be determined that the user is puffing on the electronic cigarette.

The sensor according to the embodiment may be an airflow sensing switch, a button switch or a switch of another type, which is not limited herein. The button switch may be a tact switch, a sensing switch, or a switch of another type, which is not described herein.

It is may be understood that in practical application, the electronic cigarette may determine whether the user is puffing on the electronic cigarette in other ways, which are not limited herein.

At 203, the electronic cigarette determines whether the client on the user terminal is in a standby state. If the client on the user terminal is in the standby state, step 205 may be executed, and otherwise, step 204 may be executed.

Having determined that the user is puffing on the electronic cigarette, the electronic cigarette may detect the client on the user terminal which is bound with the electronic cigarette.

It should be illustrated that according to the embodiment, the user may bind the electronic cigarette of the user with the user terminal, and specifically, the electronic cigarette may be bound to the user terminal through bluetooth connection, WIFI connection, infrared connection or NFC connection, etc.

The client installed on the user terminal may include for example an APP client or a network client, etc.

At 204 the electronic cigarette stops operation. The process is ended.

If the electronic cigarette determines that the client on the user terminal is not in the standby state, it is illustrated that the user has closed the client himself, or the user terminal has not been started at all, or the user terminal can not receive signals currently. In other words, the electronic cigarette can't communicate data to the user terminal. Therefore the electronic cigarette may stop operation and the process is ended.

At 205 the electronic cigarette transmits the information on the amount of remaining tobacco tar to the user terminal through a wireless network.

If the electronic cigarette determines that the client on the user terminal is in the standby state, it is illustrated that the electronic cigarette may communicate data to the user terminal, and then the electronic cigarette transmits the information on the amount of remaining tobacco tar to the user terminal through the wireless network.

The wireless network according to the embodiment of the disclosure may include a bluetooth network, a WIFI network, an infrared network or a NFC network, and is not described herein.

At 206 the user terminal determines whether the amount of remaining tobacco tar is smaller than a preset value, if the amount of remaining tobacco tar is smaller than the preset value, step 207 is executed, and otherwise, step 209 is executed.

Having received the information on the amount of remaining tobacco tar from the electronic cigarette, the user terminal determines whether the amount of remaining tobacco tar is smaller than the preset value according to the information on the amount of remaining tobacco tar, if the amount of remaining tobacco tar is smaller than the preset value, step 207 is executed; otherwise, step 209 is executed.

At 207 the user terminal transmits request information to the service platform.

According to the embodiment, if the user terminal determines that the amount of remaining tobacco tar of the electronic cigarette is smaller than the preset value, it is illustrated that tobacco tar is insufficient currently. Then the user terminal may transmit the request information to the service platform to request the service platform to feed back corresponding information.

At 208, the user terminal receives information about electronic cigarette accessories from the service platform, and presents the information about electronic cigarette accessories to the user.

According to the embodiment, the user terminal transmits the request information to the service platform, and then the service platform feeds back information about electronic cigarette accessories to the user terminal. The user terminal may receive the information about electronic cigarette accessories and present the information about electronic cigarette accessories to the user.

The information about electronic cigarette accessories according to the embodiment of the disclosure may include sale information of electronic cigarette accessories (such as tobacco tar, a battery rod, etc), such as a position, telephone number, promotion information and product price of a shopping mall, etc, which is not limited herein.

At 209 the user terminal executes other operations.

According to the embodiment, if the user terminal determines that the amount of remaining tobacco tar of the electronic cigarette is above the preset value, it is illustrated that tobacco tar is sufficient currently. The user terminal may execute other operations, such as recording the amount of remaining tobacco tar, or presenting the amount of remaining tobacco tar to the user, etc, which are not limited herein.

According to the embodiment of the disclosure, having received the information on the amount of remaining tobacco tar from the electronic cigarette, the user terminal determines whether the amount of remaining tobacco tar is smaller than the preset value. If the amount of remaining tobacco tar is smaller than the preset value, the user terminal transmits the request information to the service platform and presents to the user the information about electronic cigarette accessories which is fed back by the service platform. Thus, in a case that the amount of remaining tobacco tar is small, the information about electronic cigarette accessories which the user concerns may be pushed to the user, so as to implement accurate information push.

The electronic cigarette may transmit the information on the amount of remaining tobacco tar to the user terminal only when the user is smoking, so that the information on the amount of remaining tobacco tar is more accurate to meet user requirement.

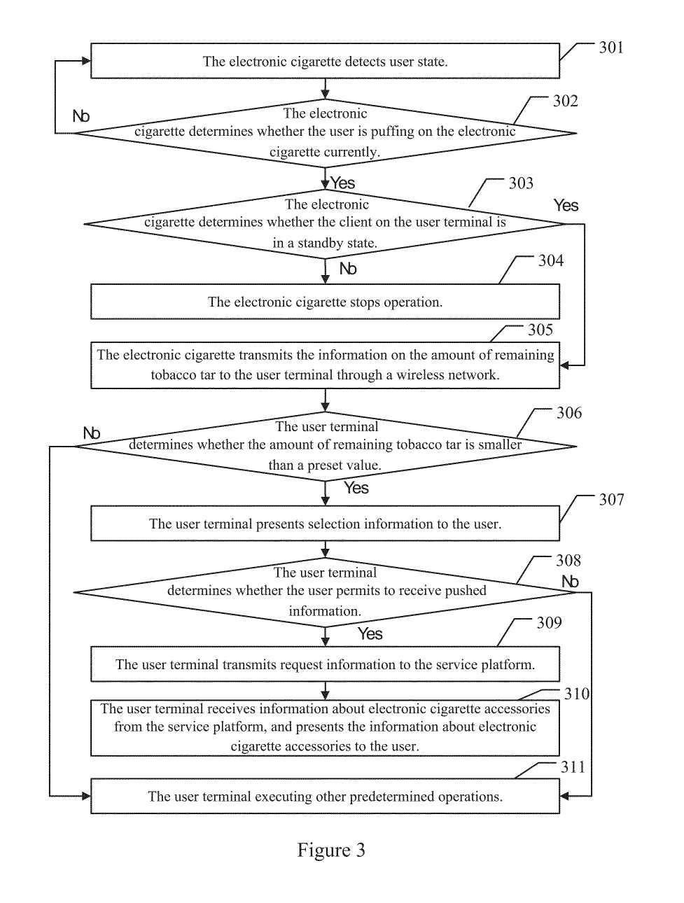

Referring to FIG. 3, the information pushing method according to still another embodiment of the disclosure includes following steps.

At 301, the electronic cigarette detects user state.

According to the embodiment, the electronic cigarette may detect the user state to acquire current user state such as the user being smoking, the user being about to smoke, the user closing the electronic cigarette, etc, which is not limited herein.

At 302 the electronic cigarette determines whether the user is puffing on the electronic cigarette currently. If the user is puffing on the electronic cigarette currently, step 303 is executed, and if the user is not puffing on the electronic cigarette currently, step 301 is executed.

Having detected the user state, the electronic cigarette may acquire the current user state, to determine whether the user is puffing on the electronic cigarette currently. If the user is puffing on the electronic cigarette currently, step 303 may be executed, if the user is not puffing on the electronic cigarette currently, step 301 may be executed repeatedly.

It should be illustrated that the electronic cigarette may determine whether the user is puffing on the electronic cigarette currently in various ways. For example, the electronic cigarette may determine whether the user is puffing on the electronic cigarette according to operation state of an atomizer assembly of the electronic cigarette. In a case that the atomizer assembly is operating, it is determined that the user is puffing on the electronic cigarette.

Alternatively, the electronic cigarette may determine whether the user is puffing on the electronic cigarette according to operation state of a sensor of the electronic cigarette. In a case that the sensor is operating, it is determined that the user is puffing on the electronic cigarette currently.

Alternatively, the electronic cigarette may determine whether the user is puffing on the electronic cigarette according to consumption rate of battery power of the electronic cigarette. In a case that the consumption rate of battery power is greater than a threshold, it is determined that the user is puffing on the electronic cigarette.

The sensor according to the embodiment may be an airflow sensing switch, a button switch or a switch of another type, and is not limited herein. The button switch may be a tact switch, a sensing switch, or a switch of another type, which is not limited herein.

It is may be understood that in practical application, the electronic cigarette may determine whether the user is puffing on the electronic cigarette in other ways, which are not limited herein.

At 303, the electronic cigarette determines whether the client on the user terminal is in a standby state. If the client on the user terminal is in the standby state, step 305 may be executed, and otherwise, step 304 may be executed.

Having determined that the user is puffing on the electronic cigarette, the electronic cigarette may detect the client on the user terminal which is bound with the electronic cigarette.

It should be illustrated that according to the embodiment, the user may bind the electronic cigarette of the user with the user terminal, and specifically, the electronic cigarette may be bound to the user terminal through bluetooth connection, WIFI connection, infrared connection or NFC connection, etc.

The client installed on the user terminal may include for example an APP client or a network client, etc.

According to the embodiment, having transmitted a client detection message to the user terminal, the electronic cigarette may determine whether a client response message is received from the user terminal. If the client response message is received, it is determined that the client on the user terminal is in the standby state, and otherwise, it is determined that the client on the user terminal is not in the standby state.

In practical application, the electronic cigarette may determine whether the client on the user terminal is in the standby state in other ways, which are not limited herein.

The user terminal according to the embodiment of the disclosure may include a cellphone, a personal computer, a laptop, a tablet computer or other similar devices, which are not limited herein.

At 304 the electronic cigarette stops operation. The process is ended.

If the electronic cigarette determines that the client on the user terminal is not in the standby state, it is illustrated that the user has closed the client himself, or the user terminal has not been started at all, or the user terminal can not receive signals currently. In other words, the electronic cigarette can't communicate data with the user terminal. Therefore the electronic cigarette may stop operation and the process is ended.

It should be illustrated that according to the embodiment, if the user has closed the client, the electronic cigarette may activate the client through triggering signaling in this step, of which implementation is common general knowledge and is not limited herein.

At 305 the electronic cigarette transmits the information on the amount of remaining tobacco tar to the user terminal through a wireless network.

If the electronic cigarette determines that the client on the user terminal is in the standby state, it is illustrated that the electronic cigarette may communicate data with the user terminal, and then the electronic cigarette transmits the information on the amount of remaining tobacco tar to the user terminal through the wireless network.

The wireless network according to the embodiment of the disclosure may include a bluetooth network, a WIFI network, an infrared network or a NFC network, and is not described herein.

According to the embodiment, the electronic cigarette may transmit the information on the amount of remaining tobacco tar to the user terminal in various ways, which may include, for example, the following ways.

First, the electronic cigarette may transmit the information on the amount of remaining tobacco tar to the user terminal in a valuePair way.

Specially, the electronic cigarette may transmit data of valuePair type to the user terminal through the wireless network, where the data of valuePair type is used to represent the information on the amount of remaining tobacco tar.

The data of valuePair type may be write as (“CigarOilLeft”, leftValue), where the leftValue is float-point data.

Second, the electronic cigarette may transmit the information on the amount of remaining tobacco tar to the user terminal in a JSON way.

Specially, the electronic cigarette may transmit data of JSON type to the user terminal through the wireless network, where the data of JSON type includes the information on the amount of remaining tobacco tar.

The data of JSON type may be write as {“CigarOilLeft”: “leftValue”}, where the leftValue is float-point data.

In the foregoing two ways, large quantity of data may be transmitted in the JSON way, and the valuePair way is suitable for transmission of single data. In practical application, transmission may be performed in one of the JSON way and the valuePair way, which is not limited herein.

It should be illustrated that besides the foregoing two transmission ways, the electronic cigarette may also use other ways to transmit the information on the amount of remaining tobacco tar, which is not limited herein.

According to the embodiment, before transmitting the information on the amount of remaining tobacco tar to the user terminal, the electronic cigarette still need acquiring the information on the amount of remaining tobacco tar through following ways.

First, the electronic cigarette may determine the information on the amount of remaining tobacco tar through a sensor.

In this way, a counter of the electronic cigarette may count the outputs of the sensor of the electronic cigarette to determine puff number of remaining tobacco tar, and the puff number of remaining tobacco tar may be taken as the information on the amount of remaining tobacco tar.

The sensor is an airflow sensing switch or a button switch which is a tack switch or a sensing switch.

In practical application, for the electronic cigarette filled with tobacco tar, the total puff number is normally a constant, for example, the puff number being 100. Thus the counter of the electronic cigarette may count the outputs of the sensor (such as an airflow sensing switch or a button switch) to determine how many times the user has puffed on the electronic cigarette, to calculate remaining puff number which is taken as the information on the amount of remaining tobacco tar.

Second, the electronic cigarette may determine the information on the amount of remaining tobacco tar through a liquid level detector.

In this way, the liquid level detector of the electronic cigarette may detect the height of the surface of tobacco tar when the electronic cigarette is in a preset state. Thus the information on the amount of remaining tobacco tar of the electronic cigarette may be determined.

The preset state includes the electronic cigarette being perpendicular or parallel to the horizontal plane.

The height of the surface of tobacco tar of the electronic cigarette perpendicular or parallel to the horizontal plane may be detected through the liquid level detector, so as to calculate the information on the amount of remaining tobacco tar of the electronic cigarette according to the height.

It is may be understood that in practical application, besides foregoing two ways, the electronic cigarette may use other ways to calculate the information on the amount of remaining tobacco tar, which are not limited herein.

At 306 the user terminal determines whether the amount of remaining tobacco tar is smaller than a preset value, if the amount of remaining tobacco tar is smaller than the preset value, step 307 is executed, and otherwise, step 311 is executed.

After acquiring the information on the amount of remaining tobacco tar from the electronic cigarette, the user terminal may first perform the following analysis.

If data received from the electronic cigarette is of valuePair type, the user terminal may directly acquire the key value according to the key name and take the key value as a specific value of the amount of remaining tobacco tar.

If data received from the electronic cigarette is of JSON type, the user terminal converts the data of JSON type into a JSONObject object, and extracts a specific value from the JSONObject according to a field identifier, which may be implemented as follows:

JSONObject jsonObject=new JSONObject (result);
float oilLeft=(float) jsonObject.getDouble (“code”).

If the user terminal determines that the amount of remaining tobacco tar is smaller than the preset value, step 307 may be executed, if the user terminal determines that the amount of remaining tobacco tar is above the preset value, step 311 may be executed.

At 307 the user terminal presents selection information to the user.

According to the embodiment, if the user terminal determines that the amount of remaining tobacco tar is smaller than the preset value, it is illustrated that the amount of remaining tobacco tar is insufficient. Then the user terminal may notify the user that the amount of remaining tobacco tar is insufficient, and present the selection information, so that the user may select whether to receive information about electronic cigarette accessories which is pushed by the service platform.

At 308 the user terminal determines whether the user permits to receive pushed information. If the user permits to receive pushed information, step 309 is executed, and if the user does not permit to receive pushed information, step 311 is executed.

At 309 the user terminal transmits request information to the service platform.

According to the embodiment, if the user permits to receive information pushed by the service platform, the user terminal may transmit the request information to the service platform to request the service platform to feed back corresponding information.

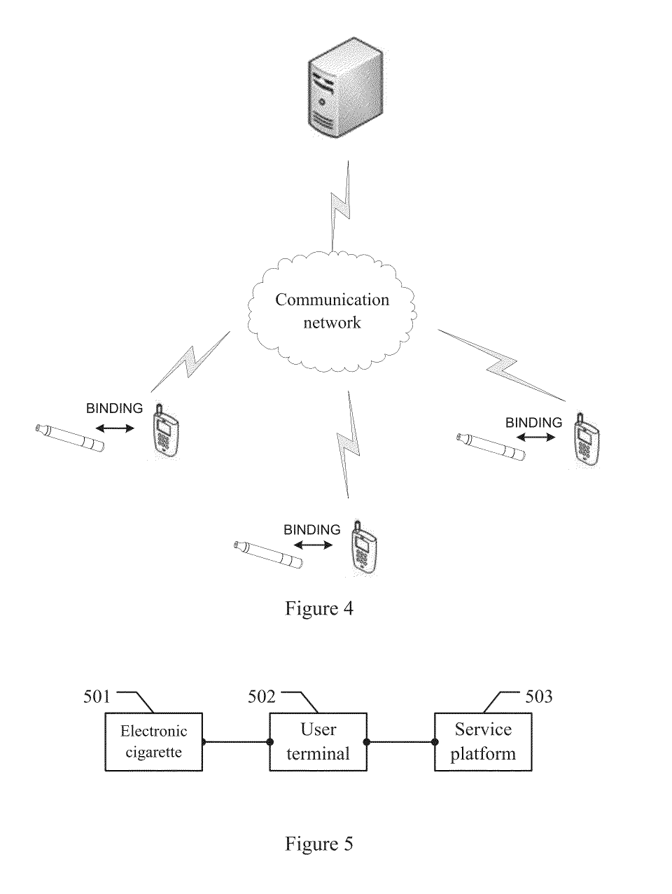

As shown in FIG. 4, in a communication frame according to the embodiment, the electronic cigarette is bound with the user terminal, the user terminal is connected to the service platform through a communication network and one service platform may provide services to multiple electronic cigarettes and multiple user terminals.

At 310, the user terminal receives information about electronic cigarette accessories from the service platform, and presents the information about electronic cigarette accessories to the user.

According to the embodiment, the user terminal transmits the request information to the service platform, and then the service platform feeds back information about electronic cigarette accessories to the user terminal. The user terminal may receive the information about electronic cigarette accessories and present the information about electronic cigarette accessories to the user.

The information about electronic cigarette accessories according to the embodiment may includes sale information of electronic cigarette accessories (such as tobacco tar, a battery rod, etc), such as a position, telephone number, promotion information and product price of a shopping mall, which are not limited herein.

According to the embodiment, the user terminal may acquire information and present the information through the following process.

(1) An entity object may be acquired by transmission of a data request through hyper text transport protocol (HTTP):

HttpEntity entity=HttpUtil.getEntity (url, null, HttpUtil.METHOD_GET);

which may be implemented as follows:

```
  public class HttpUtil {
    public static final int METHOD_GET=1;
    public static final int METHOD_POST=2;
      public static HttpEntity getEntity(String uri, List<NameValuePair> params, int
method) throws IOException{
      HttpEntity entity=null;
      HttpClient client=new DefaultHttpClient( );
  client.getParams ( ).setParameter (CoreConnectionPNames.CONNECTION_
TIMEOUT, 3000) ;
      HttpUriRequest request=null;
      switch (method) {
      case METHOD_GET:
        StringBuilder sb=new StringBuilder(uri);
        if (params! =null&&! params.isEmpty ( ) ){
          sb.append(‘?’);
          for (NameValuePair pair:params) {
            sb.append (pair.getName ( ) ).append (‘=’)
            .append (pair.getValue( ) ).append (‘&’);
            }
            sb.delete (sb.length( ), -1);
          }
          request=new HttpGet (sb.toString ( ) );
          break;
        case METHOD_POST:
          request=new HttpPost (uri);
          if (params! =null&&! params.isEmpty ( ) ){
            UrlEncodedFormEntity reqEntity=new UrlEncodedFormEntity
(params);
            ( (HttpPost) request).setEntity (reqEntity);
          }
          break;
        }
        HttpResponse response=client.execute (request);
        if (response.getStatusLine ( ).getStatusCode ( )==HttpStatus.SC_OK) {
          entity=response.getEntity ( );
        }
        return entity;
  }
```

(2) The entity object is converted into a stream object to facilitate JSON analysis:

InputStream is=HttpUtil.getStream (entity);

which may be implemented as follows:

```
public static InputStream getStream (HttpEntity entity) throws IOException{
      InputStream in=null;
      if (entity! =null) {
        in=entity.getContent ( );
      }
      return in;
  }
public static long getLength (HttpEntity entity) {
      long len=0;
      if (entity! =null) {
        len=entity.getContentLength( );
      }
      return len;
    }
}
```

(3) JSON analysis is performed, and the stream object is converted into a character string:

String result=JSONUtil.getData (is);

(4) Relevant product objects which are needed are acquired:

cigarettes=JSONUtil.JSONParse (result); and

(5) The product objects may be presented after acquiring the product objects.

It should be illustrated that in practical application, the user terminal may also acquire the information about electronic cigarette accessories for presentation in other ways, which are not limited herein.

At 311, the user terminal executing other operations.

According to the embodiment, if the user terminal determines that the amount of remaining tobacco tar of the electronic cigarette is above the preset value, or the user selects not to permit to receive information pushed by the service platform, the user terminal may execute other operations such as stopping current process, which are not limited herein.

It should be illustrated that steps 307 and 308 according to the embodiment are optional steps. In practical application, in a case that the user terminal determines that the amount of remaining tobacco tar is smaller than the preset value, instead of notifying the user to select whether to permit to receive information pushed by the service platform, the user terminal may directly transmits the request information to the service platform, and present the information about electronic cigarette accessories to the user.

According to the embodiment of the disclosure, having received the information on the amount of remaining tobacco tar from the electronic cigarette, the user terminal determines whether the amount of remaining tobacco tar is smaller than the preset value. If the amount of remaining tobacco tar is smaller than the preset value, the user terminal transmits the request information to the service platform and presents to the user the information about electronic cigarette accessories which is fed back by the service platform. Thus in a case that the amount of remaining tobacco tar is small, the information about electronic cigarette accessories which the user concerns may be pushed to the user, so as to implement accurate information push.

The electronic cigarette may transmit the information on the amount of remaining tobacco tar to the user terminal only when the user is smoking, so that the information on the amount of remaining tobacco tar is more accurate to meet user requirement.

In a case that the user terminal determines that the amount of remaining tobacco tar is smaller than the preset value, the user terminal may notify the user to select whether to permit to receive information pushed by the service platform, therefore selection right of the user may be fully guaranteed, and unnecessary disturbance to the user is avoided.

A communication system according to an embodiment of the disclosure is described in the following, with reference to FIG. 5.

The communication system according to the embodiment of the disclosure includes an electronic cigarette 501, a user terminal 502 and a service platform 503, where the electronic cigarette 501 is bound with the user terminal 502.

The user terminal 502 is configured to receive information on amount of remaining tobacco tar from the electronic cigarette 501, and determine whether the amount of remaining tobacco tar is smaller than a preset value. If the amount of remaining tobacco tar is smaller than the preset value, the user terminal 502 transmits request information to the service platform 503, receives information about electronic cigarette accessories from the service platform 503 and presents the information about electronic cigarette accessories to the user.

The electronic cigarette 501 according to the embodiment is further configured to determine whether the user is puffing on the electronic cigarette. If the user is puffing on the electronic cigarette, the electronic cigarette determines whether a client on the user terminal is in a standby sate. If the client on the user terminal is in the standby state, the electronic cigarette transmits information on the amount of remaining tobacco tar to the user terminal through a wireless network.

According to the embodiment, the user terminal 502 may be further configured to present selection information to the user.

If the user selects to permit to receive information pushed by the service platform, the user terminal 502 triggers the function for transmitting the request information to the service platform 503.

If the user selects not to permit to receive information pushed by the service platform, the user terminal 502 stops executing operation.

According to the embodiment, the electronic cigarette 501 is configured to employ a counter to count the outputs of the sensor of the electronic cigarette to determine puff number of remaining tobacco tar and take the puff number of remaining tobacco tar as the information on the amount of remaining tobacco tar.

According to the embodiment, the sensor is an airflow sensing switch or a button switch, which is a tact switch or a sensing switch.

According to the embodiment, the electronic cigarette 501 is configured to employ a liquid level detector detect the height of the surface of tobacco tar when the electronic cigarette is in a preset state, in order to determine the information on the amount of remaining tobacco tar.

According to the embodiment, the preset state includes the electronic cigarette 501 being perpendicular or parallel to the horizontal plane.

According to the embodiment, the wireless network includes a bluetooth network, a WIFI network, an infrared network or a NFC network.

According to the embodiment, the user terminal 502 includes a cellphone, a personal computer, a laptop or a tablet computer.

To facilitate understanding, the communication system according to the embodiment of the disclosure is described in detail in a specific application scenario.

According to the embodiment, the electronic cigarette 501 may detect the user state to acquire current user state such as the user being smoking, the user being about to smoke, the user closing the electronic cigarette, etc, which is not limited herein.

Having detected the user state, the electronic cigarette 501 may acquire the current user state to determine whether the user is puffing on the electronic cigarette currently.

It should be illustrated that the electronic cigarette 501 may determine whether the user is puffing on the electronic cigarette currently in various ways. For example, the electronic cigarette 501 may determine whether the user is puffing on the electronic cigarette 501 according to operation state of an atomizer assembly of the electronic cigarette. When the atomizer assembly is operating, it is determined that the user is puffing on the electronic cigarette.

Alternatively, the electronic cigarette 501 may determine whether the user is puffing on the electronic cigarette according to operation state of a sensor of the electronic cigarette. When the sensor is operating, it is determined that the user is puffing on the electronic cigarette currently.

Alternatively, the electronic cigarette 501 may determine whether the user is puffing on the electronic cigarette according to consumption rate of battery power of the electronic cigarette. When the consumption rate of battery power is greater than a threshold, it is determined that the user is puffing on the electronic cigarette.

The sensor according to the embodiment may be an airflow sensing switch, a button switch or a switch of another type, and is not limited herein. The button switch may be a tact switch, a sensing switch, or a switch of another type, and is not described herein.

It is may be understood that in practical application, the electronic cigarette 501 may determine whether the user is puffing on the electronic cigarette in other more ways, which are not limited herein.

Having determined that the user is puffing on the electronic cigarette, the electronic cigarette 501 may detect the client on the user terminal 502 bound with the electronic cigarette 501.

It should be illustrated that according to the embodiment, the user may bind the electronic cigarette 501 of the user with the user terminal 502, and specifically, the electronic cigarette 501 may be bound to the user terminal 502 through bluetooth connection, WIFI connection, infrared connection or NFC connection, etc.

The client installed on the user terminal 502 may include for example an APP client or a network client, etc.

According to the embodiment, having transmitted a client detection message to the user terminal 502, the electronic cigarette 501 may determine whether a client response message is received from the user terminal 502. If the client response message is received, it is determined that the client on the user terminal 502 is in a standby state, and otherwise, it is determined that the client on the user terminal is not in the standby state.

In practical application, the electronic cigarette 501 may also determine whether the client on the user terminal 502 is in the standby state in other ways, which are not limited herein.

The user terminal 502 according to the embodiment may include a cellphone, a personal computer, a laptop, a tablet computer or other similar devices, which are not limited herein.

If the electronic cigarette 501 determines that the client on the user terminal 502 is not in the standby state, it is illustrated that the user has closed the client himself, or the user terminal 502 has not been started at all, or the user terminal 502 can not receive signal currently. In other words the electronic cigarette 501 can't communicate data with the user terminal. Therefore the electronic cigarette 501 may stop operation and the process is ended.

It should be illustrated that according to the embodiment, if the user has closed the client himself, the electronic cigarette 501 may activate the client through triggering signaling in this step, of which implementation is common general knowledge and is not limited herein.

If the electronic cigarette 501 determines that the client on the user terminal 502 is in the standby state, it is illustrated that the electronic cigarette 501 may communicate data with the user terminal 502, and then the electronic cigarette 501 transmits the information on the amount of remaining tobacco tar to the user terminal 502 through the wireless network.

The wireless network according to the embodiment of the disclosure may include a bluetooth network, a WIFI network, an infrared network or a NFC network, and is not limited herein.

According to the embodiment, the electronic cigarette 501 may transmit the information on the amount of remaining tobacco tar to the user terminal 502 in various ways, which may include, for example, the following ways.

First, the electronic cigarette may transmit the information on the amount of remaining tobacco tar to the user terminal in a valuePair way.

Specially, the electronic cigarette 501 may transmit data of valuePair type to the user terminal through the wireless network, where the data of valuePair type is used to represent the information on the amount of remaining tobacco tar.

The data of valuePair type may be write as (“CigarOilLeft”, leftValue), where the leftValue is float-point data.

Second, the electronic cigarette may transmit the information on the amount of remaining tobacco tar to the user terminal in a JSON way.

Specially, the electronic cigarette 501 may transmit data of JSON type to the user terminal through the wireless network, where the data of JSON type includes the information on the amount of remaining tobacco tar.

The data of JSON type may be write as {“CigarOilLeft”:‘leftValue”}, where the leftValue is float-point data.

In the foregoing two ways, large quantity of data may be transmitted in the JSON way, and the valuePair way is suitable for transmission of single data. In practical application, transmission may be performed in one of the JSON way and the valuePair way, which is not limited herein.

It should be illustrated that besides the foregoing two transmission ways, the electronic cigarette 501 may also use other ways to transmit the information on the amount of remaining tobacco tar, which is not limited herein.

According to the embodiment, before transmitting the information on the amount of remaining tobacco tar to the user terminal 502, the electronic cigarette 501 still need acquiring the information on the amount of remaining tobacco tar through following ways.

First, the electronic cigarette may determine the information on the amount of remaining tobacco tar through a sensor.

In this way, a counter of the electronic cigarette 501 may count the outputs of the sensor of the electronic cigarette to determine puff number of remaining tobacco tar, and the puff number of remaining tobacco tar may be taken as the information on the amount of remaining tobacco tar.

The sensor is an airflow sensing switch or a button switch which is a tack switch or a sensing switch.

In practical application, for the electronic cigarette filled with tobacco tar, the total puff number is normally a constant, for example, the puff number being 100. Thus the counter of the electronic cigarette may count the outputs of the sensor (such as an airflow sensing switch or a button switch) to determine how many times the user has puffed on the electronic cigarette, to calculate remaining puff number which is taken as the information on the amount of remaining tobacco tar.

Second, the electronic cigarette may determine the information on the amount of remaining tobacco tar through a liquid level detector.

In this way, the liquid level detector of the electronic cigarette 502 may detect the height of the surface of tobacco tar when the electronic cigarette is in a preset state to determine the information on the amount of remaining tobacco tar.

The preset state includes that the electronic cigarette 501 being perpendicular or parallel to the horizontal plane.

The height of the surface of tobacco tar of the electronic cigarette 501 perpendicular or parallel to the horizontal plane may be detected through the liquid level detector, so as to calculate the information on the amount of remaining tobacco tar according to the height.

It is may be understood that in practical application, besides foregoing two ways, the electronic cigarette 501 may use other ways to calculate the information on the amount of remaining tobacco tar, which is not limited herein.

After acquiring the information on the amount of remaining tobacco tar from the electronic cigarette 501, the user terminal 502 may first perform the following analysis.

If data received from the electronic cigarette 501 is of valuePair type, the user terminal 502 may directly acquire the key value according to a key name and take the key value as a specific value of the amount of remaining tobacco tar.

If data received from the electronic cigarette 501 is of JSON type, the user terminal 502 converts the data of JSON type into a JSONObject object, and extracts a specific value from the JSONObject according to a field identifier, which may be implemented as follows:

JSONObject jsonObject=new JSONObject (result);

float oilLeft=(float) jsonObject.getDouble (“code”).

According to the embodiment, if the user terminal 502 determines that the amount of remaining tobacco tar is smaller than the preset value, it is illustrated that the amount of remaining tobacco tar is insufficient. Then the user terminal 502 may notify the user that the amount of remaining tobacco tar is insufficient and present selection information, so that the user may select whether to receive information about electronic cigarette accessories which is pushed by the service platform.

If the user permits to receive information pushed by the service platform, the user terminal 502 may transmit request information to the service platform 503 to request the service platform 503 to feed back corresponding information.

As shown in FIG. 4, in a communication frame according to the embodiment, the electronic cigarette 501 is bound with the user terminal 502, the user terminal 502 is connected to the service platform 503 through a communication network and one service platform 503 may provide services to multiple electronic cigarettes and multiple user terminals 502.

According to the embodiment, the user terminal 502 transmits the request information to the service platform 503, and then the service platform 503 feeds back information about electronic cigarette accessories to the user terminal 502. The user terminal 502 may receive the information about electronic cigarette accessories and present the information about electronic cigarette accessories to the user.

The information about electronic cigarette accessories according to the embodiment of the disclosure may includes sale information of electronic cigarette accessories, such as a position, telephone number, promotion information and product price of a shopping mall, and is not limited herein.

According to the embodiment, the user terminal 502 may acquire information and present the information through the following process:

(1) acquiring an entity object by transmitting a data request through hyper text transport protocol (HTTP);

(2) converting the entity object into a stream object to facilitate JSON analysis;

(3) performing JSON analysis, and converting the stream object into a character string:

String result=JSONUtil.getData (is);

(4) acquiring relevant product objects which are needed:

cigarettes=JSONUtil.JSONParse (result); and

(5) presenting the product objects after acquiring the product objects.

It should be illustrated that in practical application, the user terminal 502 may acquire the information about electronic cigarette accessories to perform presentation in other ways, which are not limited herein.

According to the embodiment, if the user terminal 502 determines that the amount of remaining tobacco tar of the electronic cigarette 501 is above the preset value, or the user selects not to permit to receive information pushed by the service platform, the user terminal 502 may execute other operations such as stopping current process, which are not limited herein.

According to the embodiment of the disclosure, having received the information on the amount of remaining tobacco tar from the electronic cigarette 501, the user terminal 502 determines whether amount of remaining tobacco tar is smaller than a preset value. If the amount of remaining tobacco tar is smaller than the preset value, the user terminal 502 transmits the request information to the service platform 503 and presents to the user the information about electronic cigarette accessories which is fed back by the service platform. Thus in a case that amount of remaining tobacco tar is small, the information about electronic cigarette accessories which the user concerns may be pushed to the user, so as to implement accurate information push.

The electronic cigarette 501 may transmit the information on the amount of remaining tobacco tar to the user terminal 502 only when the user is smoking, so that the information on the amount of remaining tobacco tar is more accurate to meet user requirement.

In a case that the user terminal 502 determines that the amount of remaining tobacco tar is smaller than the preset value, the user terminal may notify the user to select whether to permit to receive information pushed by the service platform, therefore selection right of the user may be fully guaranteed, and unnecessary disturbance to the user is avoided.

1. An information pushing method, comprising:
receiving, by a user terminal, information on an amount of remaining tobacco tar from an electronic cigarette bound with the user terminal,
determining, by the user terminal, whether the amount of the remaining tobacco tar is smaller than a preset value according to the information on the amount of the remaining tobacco tar,
in response to the amount of the remaining tobacco tar being smaller than the preset value, transmitting, by the user terminal, request information to a service platform,
receiving, by the user terminal, information about electronic cigarette accessories from the service platform, and
presenting, by the user terminal, the information about electronic cigarette accessories to a user.

2. The method according to claim 1, wherein, before receiving information on an amount of remaining tobacco tar from an electronic cigarette bound with the user terminal, the method comprises:
determining, by the electronic cigarette, whether the user is puffing on the electronic cigarette,
in response to the user being puffing on the electronic cigarette, determining, by the electronic cigarette, whether a client on the user terminal is in a standby state,
in response to the client on the user terminal being in the standby state, transmitting, by the electronic cigarette, the information on the amount of the remaining tobacco tar to the user terminal through a wireless network.

3. The method according to claim 2, wherein determining whether a client on the user terminal is in a standby state comprises:
transmitting, by the electronic cigarette, a client detection message to the user terminal,
determining, by the electronic cigarette, whether a client response message is received from the user terminal,
in response to the client response message being received, determining, by the electronic cigarette, that the client on the user terminal is in the standby state.

4. The method according to claim 2, wherein transmitting the information on the amount of the remaining tobacco tar to the user terminal through a wireless network comprises:
transmitting, by the electronic cigarette, data of valuePair type to the user terminal through the wireless network, wherein the data of the valuePair type represents the information on the amount of the remaining tobacco tar.

5. The method according to claim 2, wherein transmitting the information on the amount of the remaining tobacco tar to the user terminal through a wireless network comprises:
transmitting, by the electronic cigarette, data of JSON type to the user terminal through the wireless network, wherein the data of the JSON type comprises the information on the amount of the remaining tobacco tar.

6. The method according to claim 5, wherein before determining whether the amount of the remaining tobacco tar is smaller than a preset value, the method comprises:
converting, by the user terminal, the data of the JSON type into a JSONObject object; and
extracting, by the user terminal, the information on the amount of the remaining tobacco tar from the JSONObject object according to a field identifier.

7. The method according to claim 1, wherein before transmitting request information to a service platform, the method comprises:
presenting, by the user terminal, selection information to the user;
in response to the user selecting to receive information pushed by the service platform, triggering, by the user terminal, the step of transmitting request information to a service platform; and
in response to the user selecting not to receive information pushed by the service platform, stopping, by the user terminal, executing operation.

8. The method according to claim 2, wherein before transmitting the information on the amount of the remaining tobacco tar to the user terminal through a wireless network, the method comprises:
counting, by a counter of the electronic cigarette, outputs of a sensor of the electronic cigarette to determine puff number of the remaining tobacco tar, wherein the puff number of the remaining tobacco tar is taken as the information on the amount of the remaining tobacco tar.

9. The method according to claim 8, wherein the sensor includes an airflow sensing switch or a button switch, and the button switch includes a tact switch or a sensing switch.

10. The method according to claim 2, wherein before transmitting the information on the amount of the remaining tobacco tar to the user terminal through a wireless network, the method comprises:
detecting, by a liquid level detector of the electronic cigarette, height of a surface of the tobacco tar of the electronic cigarette in a preset state to determine the information on the amount of the remaining tobacco tar.

11. The method according to claim 10, wherein the electronic cigarette is perpendicular or parallel to a horizontal plane.

12. The method according to claim 2, wherein the wireless network includes a bluetooth network, a WIFI network, an infrared network or a NFC network.

13. The method according to claim 1, wherein the user terminal includes a cellphone, a personal computer, a laptop computer or a tablet computer.

14. A communication system, comprising:
an electronic cigarette, a user terminal and a service platform, wherein:
the electronic cigarette is bound with the user terminal; and
the user terminal is configured to:
receive information on an amount of remaining tobacco tar from the electronic cigarette,
determine whether the amount of the remaining tobacco tar is smaller than a preset value according to the information on the amount of the remaining tobacco tar,
in response to the amount of the remaining tobacco tar being smaller than the preset value, transmit request information to the service platform,
receive information about electronic cigarette accessories from the service platform, and
present the information about electronic cigarette accessories to a user.

15. The communication system according to claim 14, wherein the electronic cigarette is configured to:
determine whether the user is puffing on the electronic cigarette,
in response to the user being puffing on the electronic cigarette, determine whether a client on the user terminal is in a standby state, and
n response to the client on the user terminal being in the standby state, transmit the information on the amount of the remaining tobacco tar to the user terminal through a wireless network.

16. The communication system according to claim 14, wherein:
the user terminal is further configured to:
present selection information to the user;
in response to the user selecting to receive information pushed by the service platform, triggers the function for transmitting the request information to the service platform; and
in response to the user selecting not to receive information pushed by the service platform, stops executing operation.

17. The communication system according to claim 15, wherein the electronic cigarette is configured to use a counter to count outputs of a sensor of the electronic cigarette to determine puff number of the remaining tobacco tar, wherein the puff number of the remaining tobacco tar is taken as the information on the amount of the remaining tobacco tar.

18. The communication system according to claim 17, wherein the sensor includes an airflow sensing switch or a button switch and the button switch includes a tact switch or a sensing switch.

19. The communication system according to claim 15, wherein the electronic cigarette is configured to use a liquid level detector to detect height of a surface of the tobacco tar of the electronic cigarette in a preset state to determine the information on the amount of the remaining tobacco tar.

20. The communication system according to claim 19, wherein the electronic cigarette is perpendicular or parallel to a horizontal plane.
